(19) United States
(12) Patent Application Publication
(10) Pub. No.: US 2009/0177541 A1
(43) Pub. Date: Jul. 9, 2009

(54) METHOD AND APPARATUS FOR POINT-BASED REWARDS SYSTEM USING INTERACTIVE DEVICES AND SOFTWARE

(75) Inventors: Scott Martel, New York, NY (US); Mason C. Johnson, JR., Hopewell Junction, NY (US)

Correspondence Address: NORA M. TOCUPS, P.O BOX 698, 140 PINECREST AVE, DECATUR, GA, 30030, US

(73) Assignee: LeAD LLC, New York, NY (US)

(21) Appl. No.: 12/142,751

(22) Filed: Jun. 19, 2008

Related U.S. Application Data
(60) Provisional application No. 60/944,847, filed on Jun. 19, 2007.

(51) Int. Cl. G06Q 30/00

(52) U.S. Cl. 705/14

(57) ABSTRACT

Consumers may be rewarded by monetizing downtime in an advertising supported environment. For example, a user may be presented with a message on a wireless or other unit. Including advertising, the message may solicit a response. A trivia question may be presented. During a sporting event, a user may receive a question about the game or players. In responding, the user may earn points toward an award. Users may earn points in other ways such as by providing personal information or preferences, registering or referring other users. Advertising also may be presented to the user when points are awarded or prizes redeemed. The information presented to the user, and when, where or how it is presented, may be based on the user's preferences or demographic information. Real-time or other reports tracking the user's viewing of advertising may be made available to the advertisers or other suppliers of presented information.

### RELATED APPLICATION

This application claims priority to and the benefits of the prior filed co-pending and commonly owned provisional application entitled: METHOD AND APPARATUS FOR POINT-BASED REWARDS SYSTEM USING INTERACTIVE DEVICES AND SOFTWARE, which was filed with the United States Patent and Trademark Office on Jun. 19, 2007, which was assigned U.S. Application Ser. No. 60/944,847, and which is incorporated herein by reference.

### FIELD OF THE INVENTIONS

The inventions relate to the presentation of information. More particularly, the inventions relate to the presentation of information to users who may be provided with an incentive to view the information.

### BACKGROUND

The following list of United States patents is provided by way of background and the patents are incorporated herein by reference.

### U.S. Patent Documents

| | |
|---|---|
| Sending initial password through an SMS | Pat. No. 7,031,699 |
| | Filing date: Aug. 23, 1999 |
| | Issue date: Apr. 18, 2006 |
| User definable on-line co-user lists | Pat. No. 6,677,968 |
| | Filing date: Apr. 17, 2001 |
| | Issue date: Jan. 13, 2004 |
| Method and apparatus for interactive audience | Pat. No. 6,650,903 |
| participation at a live spectator event | Filing date: May 11, 2001 |
| | Issue date: Nov. 18, 2003 |
| Interactive system allowing real time participation | Pat. No. 5,860,862 |
| | Filing date: Jan. 5, 1996 |
| | Issue date: Jan. 19, 1999 |
| Method and apparatus for interactive audience | Pat. No. 6,434,398 |
| participation at a live spectator event | Filing date: Sep. 6, 2000 |
| | Issue date: Aug. 13, 2002 |
| Method and system for playing trivia games | Pat. No. 6,752,396 |
| | Filing date: Jul. 24, 2002 |
| | Issue date: Jun. 22, 2004 |
| Wireless communications system for a quiz game | Pat. No. 6,688,982 |
| | Filing date: Nov. 29, 2000 |
| | Issue date: Feb. 10, 2004 |
| Prize redemption system for games | Pat. No. 6,015,344 |
| | Filing date: Sep. 29, 1997 |
| | Issue date: Jan. 18, 2000 |
| Device for playing back short films and/or advertising | Pat. No. 5,743,745 |
| spots and/or quiz questions | Filing date: Dec. 9, 1996 |
| | Issue date: Apr. 28, 1998 |
| Method and apparatus for distributing location-based | Pat. No. 6,505,046 |
| messages in a wireless communication network | Filing date: Nov. 19, 1998 |
| | Issue date: Jan. 7, 2003 |
| Electronic coupon system | Pat. No. 6,862,575 |
| | Filing date: Aug. 17, 2000 |
| | Issue date: Mar. 1, 2005 |
| Method of displaying advertisement on display of | Pat. No. 7,027,802 |
| mobile communication terminal | Filing date: Dec. 11, 2001 |
| | Issue date: Apr. 11, 2006 |
| Automatic messaging in response to television | Pat. No. 7,054,654 |
| viewing | Filing date: Feb. 24, 2004 |
| | Issue date: May 30, 2006 |
| Predefined messages for wireless multiplayer | Pat. No. 6,908,389 |
| gaming | Filing date: Mar. 7, 2001 |
| | Issue date: Jun. 21, 2005 |
| Method of conducting an interactive competition | Pat. No. 6,800,031 |
| | Filing date: Apr. 15, 2002 |
| | Issue date: Oct. 5, 2004 |
| Real-time wireless audience response system | Pat. No. 5,226,177 |
| | Filing date: Aug. 3, 1992 |
| | Issue date: Jul. 6, 1993 |
| System for evaluation and rewarding of responses | Pat. No. 5,034,807 |
| and predictions | Filing date: Oct. 19, 1989 |
| | Issue date: Jul. 23, 1991 |
| System and method for interactive game-play | Pat. No. 6,758,754 |
| scheduled based on real-life events | Filing date: Aug. 13, 1999 |
| | Issue date: Jul. 6, 2004 |
| Enhanced online game mechanisms | Pat. No. 6,676,521 |
| | Filing date: Aug. 18, 2000 |
| | Issue date: Jan. 13, 2004 |
| System and method for incentive programs and | Pat. No. 6,061,660 |
| award fulfillment | Filing date: Mar. 18, 1998 |
| | Issue date: May 9, 2000 |

### SUMMARY

Generally stated, the inventions relate to methods, systems, and apparatuses for presenting information to a user in a manner such that the user may elect to continue to view presented information. The information may be presented in a convenient fashion to the user such as through a communication transmitted to a device or devices as selected and/or operated by the user. The information may be presented at times as may be selected by the user. The presented information may be selected based on the user's preferences and/or demographics. To provide the user with an incentive to view the information, the user may be provided with a way to obtain a reward for such viewing. For example, the information may be presented together with a game or a question. The user may score points for participating in the game, answering the question, or providing a question or game. As the user views more messages with presented information and the games or questions and responds to them, the user may accumulate points. If the user provides personal information such as through registering, refers another user, or provides a question or a game for use with the service, the user may score additional points. The user may exchange points for prizes. The prizes may serve as the incentive for the user to view the presented information. The source of the presented information or other third party may be provided with reports or tables relating to the user's viewing the presented information.

The inventions may be implemented in any number of ways. A first exemplary method according to the inventions provides an incentive to view information. A response opportunity including information is transmitted. If a response is received, points towards a point total may be awarded. Another opportunity to earn at least an additional point towards the point total may be provided. In response to receiving a request to redeem the point total for a reward, it may be provided in redemption of the point total.

Another exemplary method of the inventions gets a consumer to view advertisements by creating a message. It includes least advertising and information that solicits a response from the consumer. The message is sent to the consumer. If a response is received from the consumer, a point reward is awarded. The consumer is informed of the point reward. The consumer is allowed to redeem the point reward for an award, or to accumulate an additional point reward by responding to another message including another advertisement. Thus, the prospect of the award gets the consumer to view the advertisements.

A third exemplary embodiment of the inventions provides a method for a user to earn an award in return for being presented information. The exemplary method may receive query preference information from the user. The exemplary method may send a message to the user. The message may include at least a query according to the query preference information and presentation information. The exemplary embodiment may report the sending of the message to the user to a third party such as the source of the presentation information. The exemplary method may receive a query response from the user. A score is sent to the user. The previously sent presentation information and/or new presentation information may be sent with the score. The score may be based on the query response of the user.

These actions of sending a message, receiving a query response, and sending a score may be repeated, but a new query, a new query response, and a new score may be substituted in each repetition of the actions. The content of the presentation information may stay the same through the repetition of the actions or change. A user may be able to earn a score in ways other than by responding to a query in a message. The user may refer another user and be awarded a referral score. The exemplary method may calculate a total score for the user. The exemplary method may receive a request from the user to redeem the total score for the award. If so, the exemplary method may provide the award to the user.

The third exemplary method may be modified in many different ways including the following. For example, the user may register or otherwise provide registration information. The exemplary method may receive this registration information and make it available to a source associated with the presentation information. As an alternative or in addition, the exemplary method may send the user a registration score in response to receipt of the registration information. This registration score may be included as part of the total score of the user. As yet another alternative or in addition in response to receiving registration information from the user, this exemplary method may select the presentation information based on the registration information.

As noted in the third exemplary method, a user may provide query preference information. In response, the exemplary method may select the presentation information based on the query preference information. The query preference information may include preferred query subject matter, preferred query delivery frequency, identification of a preferred query destination of the user, preferred query day and time, and/or identification of an event.

The third exemplary embodiment also may include report capabilities. For example, the embodiment may be able to create a report including the registration and/or query preference information of the user. The report may include details about the sending of the message to the user or other actions of the embodiment. Further, the report may include information related to the inclusion of the presentation information in a message sent to a user. The report may be made available to a source of the presentation information.

### BRIEF DESCRIPTION OF THE DRAWINGS

FIG. 1. is a diagram of an exemplary registration process for a new participant.

FIG. 2. is a diagram of an exemplary system interaction with a participant.

FIG. 3. is an illustration of an exemplary event-based participant-triggered scenario.

FIG. 4. is an illustration of exemplary group play using multiple devices for interaction with the central computer system or software program.

### DETAILED DESCRIPTION

The inventions are described in detail herein sufficiently for a person skilled in the art to make or use the inventions. The inventions are described by reference to exemplary embodiment including devices and methods. The inventions, however, should not be limited to these embodiments, but may also include other elements, actions, apparatuses, and methods (not specifically described) in accordance with the inventions.

More particularly stated, the inventions may be implemented by an exemplary system and/or method that may include a centralized computer (and/or otherwise) system or software program (and/or other source) for one or more participants to accumulate points within an account profile based on responding to system-generated, participant-created (and/or otherwise generated) messages through a variety of devices such as a personal digital assistant (PDA), cellular phone, handheld personal computer (PC), internet or other messaging service, interactive voice response (IVR) system, wireless unit, electronic mail, and/or other devices. The device(s) may be wireless, may be Internet connected, may be short message service (SMS) compatible, or even a television remote control.

The inventions may be implemented by a method and/or system that may provide one or more participants with a reward as the result of participation in a point-based value system based on one or more valid (and/or other) responses to respectively one or more user-created, system-generated (and/or otherwise generated) messages through one or more interactive (and/or other) devices. One or more messages may be sent by the central computer system or software program (and/or other source) to one or more participants through wireless, Internet-connected computer, PDA, cellular device, SMS-compatible device, television remote control, and/or by an interactive voice response (and/or other device). The centralized computer system or software program (and/or other source) may select one or more participants based on one or more demographics, subscribed categories and/or events and/or otherwise such as randomly. The centralized computer system or software program (and/or other source) may send an inquiry (and/or other) message to one or more devices associated with a participant(s) such as a PDA, cellular phone, SMS/MMS, handheld PC, video gaming console, internet messaging service, and/or by electronic mail and/or other. The system may insert and/or add and/or substitute content such as a graphic image and/or a line of text into the message prior to sending the message(s) to the participant(s). All or part of the content may be based on one or more advertisers' (and/or one or more other content sources') defined criteria. All or part of the content may be supplied by the one or more advertisers, participants, or a third party and/or others. Individual participants may respond to a message(s) through an interactive device(s). The centralized computer system or software program may award a predetermined point (and/or other) value to each participant's account profile based on the validity (and/or other characteristic) of the participant's and/or participants' response(s). The point value system allows a participant to redeem accumulated points for coupons, gifts, goods or services of monetary (and/or other) value. The centralized computer system or software program may transmit inquiries and/or messages to participants based on live, broadcast, digitally recorded, Internet-streamed, archived spectator events and/or prepared question and answer games (and/or otherwise). Participants may also be rewarded with points for adding one or more new participants to the database of active participants as well as submitting content, category-based and/or event-based inquiries to be sent by the centralized computer system or software program to new participants and/or otherwise

Each participant or user may create a unique (and/or not unique) account(s) on the system. Each participant may subscribe to one or more areas of interest, demographics, and/or event categories (and/or other fields). A participant's subscription may determine eligibility for messages. The system may send a communication such as a message or a predetermined (and/or other) inquiry and an associated assigned point value (may be random). The communication or message may include a system-inserted advertisement message (and/or other content) from an advertiser, third party, (and/or other content source) as may be directed by the system (and/or otherwise). The message may be sent based on a set time interval, based on a triggered mechanism, and/or an event and/or one or more other trigger(s). A response from a participant may be validated against a predetermined reply for the particular message sent to the participant (and/or otherwise). A participant may be provided access to a web-based portal (and/or other entry) for redeeming points for gifts, coupons, goods and/or services by advertisers (and/or one or more others). Collected data of sent messages, total replies and total validated replies as well as any other information relating to the system, participants, advertisers, other sources, and the like may be stored by system (and/by other storage device or process) and may be made accessible to one or more selected advertisers and/or one or more others.

The invention may include a centralized system (and/or other source such as a software program) that may carry out (or cause an other entity(ies) to carry out) one or more of the following actions:
(i) Description of centralized computer system (and/or) software program
(ii) Process of Registering for Service through an Interactive Device
(iii) Inserting, adding, and/or substituting one or more advertisements and/or other content based on one or more criteria into a message to a participant
(iv) Selecting the content for a message to a participant or designated groups of participants based on one or more criteria relating to the service, the participant, an advertiser and/or other content source, and/or other criteria.
(v) Allowing a participant to trigger one or more messages (such as a series) to be system-sent (and/or otherwise) messages to one or more devices of the participant's choosing.

The inventions may involve a system or software program by which advertisers may deliver their content to individuals or groups of individuals in a time-sensitive, controlled, and measurable environment. An exemplary embodiment of the inventions takes into account the addition of new individuals and the continued participation by registered individuals to create a relatively large database of system users. By combining gathered demographics of an individual participant and/or a group of participants and providing incentives for users to interact with the system, advertisers can target specific participants and/or groups of participants for marketing campaigns. Participants can receive points by replying to system-generated inquiries over the course of time. Points may be accumulated in a participant's account by responding to messages through a 2-way communication device and/or custom software such as a cellular phone, SMS/MMS-compatible device, television remote control, online gaming system, and/or internet-connected device otherwise. The system may be centralized. The points may be referred to as “account points”, point rewards, scores, awards, or otherwise. A response message from a participant may include an answer to a question or inquiry contained in the original message. A point value may be assigned to a response. A higher (and/or different) point value may be assigned to a correct response (compared to an incorrect response) to a question in the original message. By interacting with the system, participants may enjoy using their knowledge or guessing the outcome of an event in their selected categories to reward themselves with gifts, coupons, goods and/or services that may be of a monetary value or not. A participant may communicate with the system through several different interactive devices (at the same time or in series) for entertainment, testing their knowledge, and/or to compete against an individual(s) and/or groups of individuals during a timeframe and/or otherwise.

By combining an individual's enjoyment of gaining knowledge, entertaining themselves, or guessing the outcome of an event, the interactive communication through a variety of devices, and a system for rewarding responses with gifts, coupons, items and/or services of monetary or other value, participants can have a unique experience in participating in their area of interest or sporting event on a continual and unified environment. As a benefit of continual participation by individuals with a known demographic, advertisers may selectively present their market message or content through the system. This data can be analyzed to help marketers better understand their target audience.

Advantageously, the inventions may provide an exemplary comprehensive system that allows individuals or groups of individuals to interactively participate in an educational and entertaining format through a variety of communication devices or software systems while rewarding them on a unified singular platform for responding to messages and advertising content based on their preferred communication method.

i) Description of Centralized Computer System (and/or) Software Program

The centralized computer system (and/or) software program (and/or other source) may process the registration of a new participant(s), select an advertiser(s)' message and predefined queries, initiate a messages or messages to a participant(s), validate a participant's response, and calculate point system total per individual or groups of individuals. The centralized computer system (and/or) software program may include a series of programmed instructions which manipulate participants' data, advertisers messages, point totals, queries, list of participants with in groups, and/or tabulations of responses, and/or other elements. The computer system or software program may provide a mechanism by which an individual may redeem earned points for coupons, gifts, or items and services of value or donate to charity. Redemption may be handled by the system providing the individual or other redeemer with either a uniquely generated printable document, a displayed graphic image, a bar code, RFID device or a plastic card that uniquely defines the participant's account

### ii) Process of Registering for Service Through an Interactive Device

The inventions may be implemented through an exemplary method for registering one or more persons for a subscription-based messaging service through wireless Internet-connected devices, SMS/MMS compatible devices, electronic mail, television remote control, online video gaming device, instant communications protocols and/or over the phone via interactive voice response system. The service may be subscription-based. The service may be a messaging service. The process may include collecting participant information such as participant name, cell phone number, cell phone service provider, television provider, and demographics such as age, address, state, zip code and preferred method of communication. The registration service may allow participants to enter demographic information over the course of time in exchange for points. The registration service may be designed to subscribe one or more participants to one or more inquiries such as combination of predetermined and/or event-based inquiries.

A exemplary method may provide a registration process for a new participant or participants using a website, an instant messaging client, a SMS/MMS-compatible device, a television remote control an online video gaming system, by electronic mail, and/or by an automate interactive response system via a telephone number, and/or otherwise.

Exemplar methods may allow a new participant(s) to initiate 2-way (and/or other) communication with a computer system or software program in one or more of the following ways: through an instant messaging Client via a predetermined keyword or phrase, through an SMS/MMS compatible device via a predetermined keyword, phrase, or predefined set of numeric or alphanumeric characters, via a television remote control device, via electronic mail, via an Internet-connected video gaming device, via the website, with an interactive voice response system (and/or otherwise).

An exemplary embodiment may include a method which validates the new participant(s) name against a database of existing participant(s) (and/or otherwise).

An exemplary embodiment may include a method in which a predetermined keyword or phase (and/or other trigger) sent to a computer system or software program triggers a process within/out the computer system or software program for collecting data regarding a participant such as participant name, gender, address, zip code, state, cellular telephone number, areas of interests, and preferred method of communication.

An exemplary embodiment may include a method by which the computer system or software program may allow a participant to determine the demographics to be stored in his/her profile and the ability to modify and add profile information over the course of time.

An exemplary embodiment may include a method in which the computer system or software program provides a new participant with a participant name (that may be temporary) and/or a password for completing the registration of the participant through a website (and/or otherwise) at a later time.

An exemplary embodiment may include a method in which an individual can be presented an opportunity to complete registration after interacting with the system anonymously after a period of time or after a pre-determined number of answered inquiries.

An exemplary embodiment may include a method by which accumulated points as an anonymous user can be transferred to a participants account profile upon completing registration

An exemplary embodiment may include a method by which the computer system or software program may confirm the identity of the participant by prompting the participant to verify account information based on stored information within their profile.

An exemplary embodiment may include a method by which new participant(s) receive points using their participant name and/or password and transferring accumulated points to an individual account upon completion of registration.

An exemplary embodiment may include a method of allowing participant(s) to control the number of inquiries they receive each day (and/or over some other time period), the participant's preferred method of communication such as SMS/MMS, web-based, through a video gaming device, electronic mail, television remote controls or instant messaging client, (and/or other method and/or device), and what time(s) during the day (and/or other the periods) the participant(s) wishes to receive messages from the system.

An exemplary embodiment may include a method of grouping inquiries within the system database into categories and subcategories that may be based on subject matter and/or event. An exemplary embodiment may include a method by which participant(s) may select which categories and/or subcategories of inquiries to receive.

An exemplary embodiment may include a method by which participants(s) may select to include or exclude advertisers, products, services, in a related field from being advertised during the course of their participation.

(iii) Inserting, Adding, and/or Substituting One or More Advertisements and/or Other Content Based on One or More Criteria into a Message to a Participant

An exemplary embodiment may include a method for inserting and/or content predetermined advertiser's text messages and/or graphics into SMS/MMS (and/or other) messages. The content may be predetermined. The content may be received from another source such as an advertiser. The content may include text messages and/or graphics. The result of the insertion/addition of content may be a combination of the content plus the previous content of the message. Either content inserted/added and/or original content may be between participants and/or between a participant(s) and the computer system or software program.

The method may include one or more of the following:
1. A database of user profiles that include a participant's name, address, service provider, content provider, age group, gender, interests and/or demographics and/or other information.
2. An advertisement server which allows advertisers to create a text message and/or provide a graphic file to be placed within the advertiser's profile within the system.
3. A centralized computer system or software program which allows an advertiser to determine the selection criteria of which group of participants receive the advertiser's message.
4. Insertion of a selected advertiser's message from the advertisement server into the centralized computer system (or software program)-generated (and/or other) inquiry sent to the participant.
5. A filtering process by the centralized computer system or software program to only send an advertiser's message in either text and/or graphic format to a group of participants based on the criteria set by the advertiser.
6. A reporting system by which advertisers can view the number of advertisements sent, how many participants replied to the message, and/or when each reply was sent, and/or other data. Collected data may be presented in the form of results viewable through a website and/or a downloadable file (and/or otherwise).
   (iv) Selecting the Content for a Message to a Participant Based on One or More Criteria Relating to the Service, the Participant or Group(s) of Participants, an Advertiser and/or Other Content Source, and/or Other Criteria.

Exemplary embodiments may be implemented to include a method and system for delivering information such as advertisements to participants via wireless devices such cellular phones, SMS/MMS compatible devices electronic mail, Internet-connected video gaming devices, television remote control, Internet-connected communication devices or interactive voice response system (and/or otherwise). The information delivery may be carried out through a series of predetermined and event-based inquiries and responses. By responding to a series of inquiries, a participant may accumulate point vales within their profile on the centralized computer system or software program. A correct response may be accorded a different point value from another response. The centralized computer system (and/or) software program may determine specific point values to valid responses based on a participant's activity point ranking, at random and/or other criteria. The point value system allows participants to redeem point values for coupons, gifts and/or items of monetary (and/or other) value. Redemption of coupons, gifts, or items of monetary value may come in the form of displayed unique alphanumeric code, a displayed graphic image or bar code on a mobile device, Internet-connected handset, handheld gaming device, or cellular phone.

An exemplary embodiment may include a method of sending predetermined or event-based inquiries based on defined categories, subcategories and/or events.

An exemplary embodiment may include a method of allowing advertisers to select a group of participants to send their advertisements to based on frequency of responses, percentage of correct replies age, gender, address, zip code, state and/or other characteristic and/or category.

An exemplary embodiment may include a method of allowing advertisers to select which day and/or time of day their advertisements or content are to be sent through the centralized computer system or software program to participants.

An exemplary embodiment may include a method of inserting advertisements and/or an advertiser's content into each sent message centralized computer system (and/or) software program prior to delivery to a participant's (or group of participants) communication device.

An exemplary embodiment may include a method of delivering formatted inquiries to participants via wireless devices, cellular devices, electronic mail , television remote control, SMS/MMS compatible, video gaming devices, and Internet-connected devices and/or through the interactive voice response systems in the form of multiple choice format which may include two or more possible responses.

EXAMPLE: Query 14: Description of Query

1. Answer

2. Answer

3 Answer

4. Answer

Advertisers Message or Advertisers Name”

A delivered inquiry may contain a suggestion for a response, a response, a possible two or more possible responses.

An exemplary embodiment may include a method of allowing a registered participant to respond with the correct answer to centralized computer system or software program-sent question.

EXAMPLE: “1”

An exemplary embodiment may include a method by which the centralized computer system or software program may provide validation to the participant of a correct or incorrect answer.

An exemplary embodiment may include a method of inserting an advertisement based on the advertiser's criteria into the web page, electronic mail, SMS/MMS message, instant messaging message, or interactive voice response system into the validation message along with a point total.

EXAMPLE: “Incorrect. The correct answer is C.

Advertiser's Message or Advertisers content or graphic”

An exemplary embodiment may include a method of associating correct responses with a point value.

An exemplary embodiment may include a method of adding an assigned point value to a participant or a grow of participants accumulated point total upon receiving a valid reply within the centralized computer system or software program.

An exemplary embodiment may include a process of allowing a participant or a group of participants to accumulate points to their total number of points within their respective participant or group profile.

An exemplary embodiment may include a method of allowing a participant to redeem a portion or full amount of accumulated points for an item or items such as coupons, gifts, or items of monetary value.

An exemplary embodiment may include a process by which a participant can initiate a series of inquiries sent to their instant messenger client by the central computer system or software program by sending a predetermined phrase or keyword to the instant messaging gateway of the central computer system or software program.

An exemplary embodiment may include a process by which a participant can initiate a series of inquiries sent to their SMS/MMS compatible device by the centralized computer system by sending a predetermined phrase or keyword to the SMS/MMS gateway of the centralized computer system or software program.

An exemplary embodiment may include a process by which a participant can initiate a series of inquiries sent to them by the centralized computer system by calling a toll free number, authenticating by a unique series of numbers and/or their registered telephone number(s) and selecting which method of communication to utilize for a predetermined series of inquiries.

An exemplary embodiment may include a process by which a participant can initiate a series of inquiries to be sent to their web browser by the centralized computer system or software program by authenticating themselves by participant name and/or password on the website (and/or otherwise) and electing to start the series of inquiries.

An exemplary embodiment may include a A process by which a participant can initiate a series of inquiries to be sent to television by the centralized computer system or software program by authenticating themselves by participant name and/or known password (and/or otherwise) and electing to start the series of inquiries via keypad input on a television remote control.

An exemplary embodiment may include a process by which a participant can initiate a series of inquiries to be sent via electronic mail by the centralized computer system or software program by sending an email to the system (and/or otherwise).

An exemplary embodiment may include a process by which a participant can initiate a series of inquiries sent to item by the centralized computer system or software program by sending a predetermined phrase and/or keyword to the centralized computer system or software program though an Internet-connected video gaming device (and/or otherwise).

An exemplary embodiment may include a process by which the centralized computer system or software program allows participants to initiate a contest between one or more additional participants via instant messaging an Internet-connected video gaming device, SMS/MMS, television remote control device, or through the website (and/or otherwise).

In an initiated group session, an exemplary embodiment may include a process that allows a participant to invite other participant(s) into a private group of participants.

An exemplary embodiment may include a method by which the centralized computer system or software program may send predetermined or event-based inquiries to each participant within a defined group, and allow each participant to respond to the inquiry.

An exemplary embodiment may include a method by which the computer system or software program allows participants within the group to provide a number of points as a wager during the predetermined set of inquires.

An exemplary embodiment may include a method by which the participant or group of participants with the highest number of valid responses from computer system or software program generated inquiries receive the sum of all wagered points.

An exemplary embodiment may include a method by which each participant's (within the group) reply may be processed and participants are awarded points individually by comparing each participant's answer with the centralized computer system of software program's defined valid responses.

An exemplary embodiment may include a method by which a participant that does not reply to the inquiry within a centralized computer system or software program defined time interval will be removed from the group.

An exemplary embodiment may include a method by which the centralized computer system or software program responds to the participants within a group with the ranking summary of points for all or a portion of the participants within the group on a predetermined time interval and provide a summary of point rankings of multiple groups.

An exemplary embodiment may include a process by which a participant may invite other participants to be grouped into a team in which participants individual point total are compiled as group's point total and compete against other teams by comparing their cumulative point totals for either a series of predefined inquiries or event-based inquiries.

An exemplary embodiment may include a process in which the centralized computer system or software program reports via an Instant message, electronic mail, website or SMS/MMS message on the participant's team total and their rank in respect to a point total versus the competing team from highest to lowest. EXAMPLE:

“competiton: <competitionname>

<highest point total> : team #1
<next highest point total> : team #2
<third highest point total> : team #3

An exemplary embodiment may include a process by which a participant can invite other participant(s) to be part of a group in which individuals can compete over a participant-determined period of time to accumulate the most points.

An exemplary embodiment may include a process in which the centralized computer system or software program reports via an Instant message, electronic mail, website or SMS/MMS message to the list of the participants within their group and their rank in respect to a point total from highest to lowest. EXAMPLE:

“Group: <groupnname>

<highest point total> : participant name #1
<next highest point total> : participant name #2
<third highest point total> : participant name #3

An exemplary embodiment may include a process by which the list of individual participants point totals within a group may be sent to the participants within the group based on a participant's initiated web request, SMS/MMS message, electronic mail, or instant message using keywords or phrases (and/or otherwise).

An exemplary embodiment may include a process by which the centralized computer system or software program can send out a list of point totals of each participant within a list based on a scheduled time interval. The list of participants is created by invitation from one participant to another or by the system.

An exemplary embodiment may include a method by which the centralized computer system or software program allows a participant to redeem a portion or the total of accumulated points for a uniquely identified printable document, a displayed graphic, a barcode or unique alphanumeric code (either/or) which entitles the participant to product or service of monetary value.

An exemplary embodiment may include a system or process that may rely on a third party for delivering a printable document, a displayed image, a displayed bar code on a website, portable Internet-connected device, mobile handset, or a unique alphanumeric code which entitles the participant to a gift, a coupon, product and/or service of monetary (and/or other) value.

An exemplary embodiment may include a method by which an advertiser can view the number of inquiries sent, the number of responses, and/or a log of the customers which responded through a password protected website.

An exemplary embodiment may include a method by which advertisers can input content and/or messages into the centralized computer system or software program, and determine the demographic to be advertised to, the time frame for advertisements to be delivered to participants, the number of advertisements to be sent, and which corresponding categories and subcategories in which the advertisements will be incorporated into.

An exemplary embodiment may include a method by which participants can suspend activity within their account by communicating to the centralized computer and/or software program via a registered wireless device, cellular device, via electronic mail, television remote control, SMS/MMS compatible device, video gaming devices, and/or Internet-connected devices.

An exemplary embodiment may include a method by which an individual participant can submit content the system for delivery to a specific group of other participants at a specific time and a specific method.

### (v) Allowing a Participant to Trigger One or More Messages (Such as a Series) to be Sent by the Centralized Computer System or Software Program to One or More Devices of the Participant's Choosing.

The inventions may include exemplary embodiments that may include a system and/or a method for a participant to trigger the receipt of messages to a communications device. The participants may be a registered or unregistered participant within the system. A participant may receive a message(s) on his or her preferred communication device. A participant may receive a message(s) during a particular time interval or an event that may be specified by a centralized computer system or software program. The trigger may be used for initiating messages may be made by means of separate and/or independent communication between a participant and a communications device. A participant can initiate the delivery of a series of messages to their preferred communication device by sending an alphanumeric SMS/MMS message to a central system to a SMS/MMS gateway, entering a key phase or keyword through an instant message client, sending an email to a mail system, selecting a menu option on a web browser, or calling a telephone number and selecting their preferred method via a keypad input through an interactive voice response system (and/or otherwise). A participant may stop the delivery of messages to their preferred (and/or other) device via a subsequent initiation by one of these methods.

An exemplary embodiment may include a method of recognizing a participant by a unique number and/or code specific to the participant's information profile in a centralized database (and/or other storage).

An exemplary embodiment may include a method of identifying a participant initiating the session through a SMS/MMS message from his/her telephone number (ANI—Automatic Number Identification), through an instant message client by his/her registered instant message username, by email by means of his/her email address, through a secure website using a username and/or a password, by calling a telephone number and having the centralized computer system or software program recognize the telephone number (ANI—Automatic Number Identification ) associated with their existing participant account, by the participant calling a telephone number and entering the participant's telephone number inputted via the handset and/or keypad through an Interactive Voice Response System (and/or otherwise).

An exemplary embodiment may include a method of verifying a participant as a registered participant by verifying their user information as stated above against a database of participant profiles.

An exemplary embodiment may include a method of providing a participant with the ability to choose his/her preferred method of communication between the participant and the centralized computer system or software program for the duration of the messages set by the centralized computer system or software program once the participant is verified.

An exemplary embodiment may include a method of allowing the participant to select a SMS/MMS compatible device, an instant messaging client, electronic mail, a web browser, and/or an web browser as a preferred method(s) to receive messages during the time duration set by the centralized computer system or software program and/or otherwise.

An exemplary embodiment may include method of allowing a participant to stop messages to his/her preferred device through the actions described above.

The following description is by example only and should not be interpreted as limiting the invention in any way. Some alternatives may be mentioned and these alternatives also are not to be limiting. Moreover, the plural refers to the singular and vice versa. Further, the “steps” referenced below may be interpreted as “actions”. Not all of the steps or their elements are necessary to the invention.

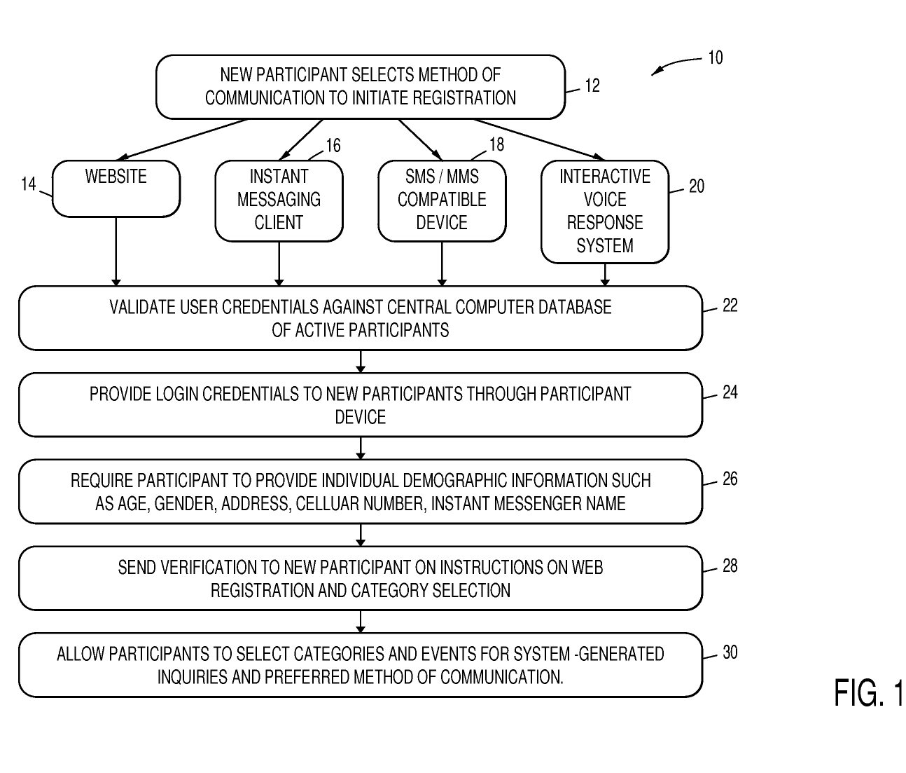

FIG. 1 illustrates an exemplary registration process 10 according to an exemplary embodiment for new participants. A new participant elects 12 to utilize an interactive communication device or system such as a website 14, an instant messaging client 16, a SMS/MMS compatible device 18, or an interactive voice response system (and/or the like) 20 to initiate registration to the service. The centralized computer system or software program may prompt the participant to select either new participant registration or to modify an existing participant's account. The exemplary process may validate 22 the user's credentials against a central computer database of active participants. The centralized computer system or software program may provide 24 login credentials to the new participant. The credentials may be unique to the participant. The centralized computer system or software program may request 26 the new participant to provide demographic information such as address, age, gender, cellular number, email address, instant messaging name, areas of interests such as knowledge or sports topics and/or web login name and password. The centralized computer system or software program may send 28 a verification message to the participant through the original method of communication. The message may provide instructions on completing registration and selecting categories. The centralized computer system or software program may provide a temporary account profile for unregistered participants up until the registration process is completed. The centralized computer system or software program may provide 30 a listing of categories in which the new participant may subscribe as well as identifying the participant's preferred method of communication for future messages.

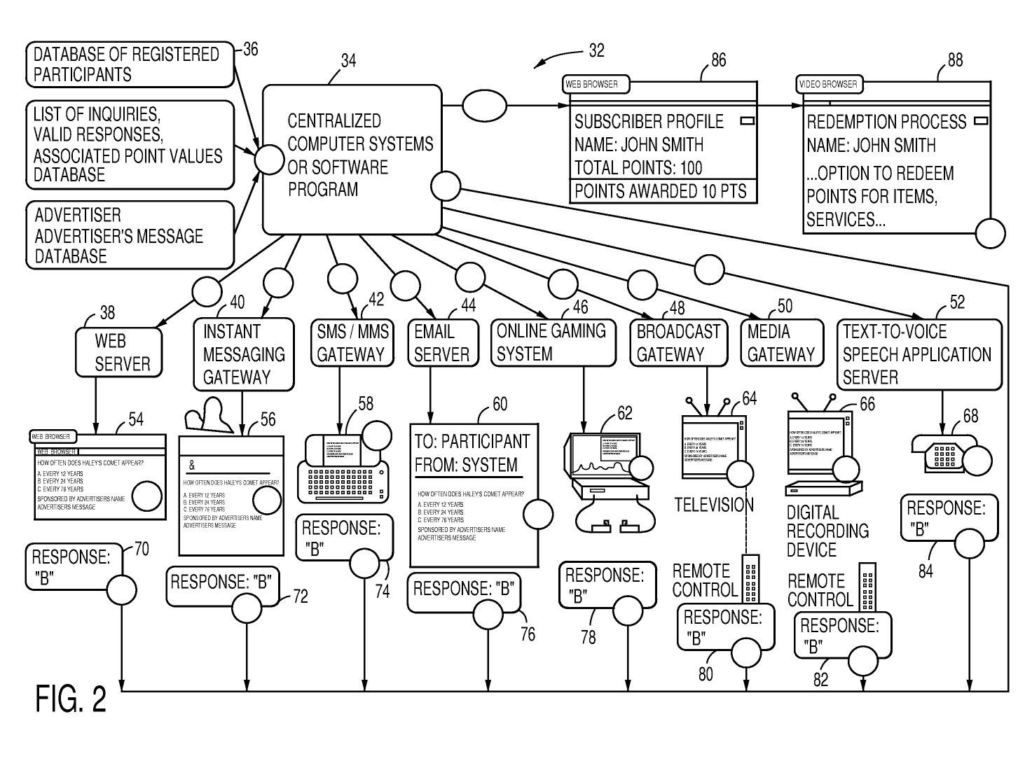

FIG. 2 illustrates implementation of an exemplary embodiment 32 of the inventions by the interaction between the centralized computer system or software program 34 and participants. The centralized computer system or software program 34 may compile a database 36 or list of registered participants based on demographic criteria, an intended inquiry, an advertiser's message or content, an associated point value for the inquiry, and/or other basis. The demographic criteria may be provided by a third party such as an advertiser. The centralized computer system or software program 34 may send a compiled inquiry to a gateway system such as a web server 38, instant messaging system 40, a SMS/MMS gateway 42, email server 44, online gaming system 46, broadcast gateway 48, media gateway 50, TEXT-TO-VOICE speech application server 52 and/or other device for delivery to a participant's communication device.

The inquiry may viewed on one or more of the following: a participant's web browser 54, instant messaging client 56, SMS/MMS compatible device 58, email client 60, online gaming system 62, television 64, video recording device 66, a TEXT-TO-VOICE speech application server for playback over a telephone handset 68, and/or other device.

A participant may respond to the inquiry with a (keyed or otherwise) response through an input device such as key 70, keyboard 72, keypad 74, email response 76, user interface device of an online gaming system 78, television remote control 80, remote control device of a video recording device 82, keypad of the telephone 84, and/or otherwise.

A response may be received by the centralized computer system or software program 34 and validated against a predetermined response. If a response is correct, the associated point value may be added to the participant's cumulative point total. Invalid responses may be discarded for point accumulation, but may be recorded and counted. Participants may be able to access profile information and point totals through a website 86 and similarly participants may redeem a portion or the entirety of their accumulated points for a product and/or service of monetary (and/or other) value 88.

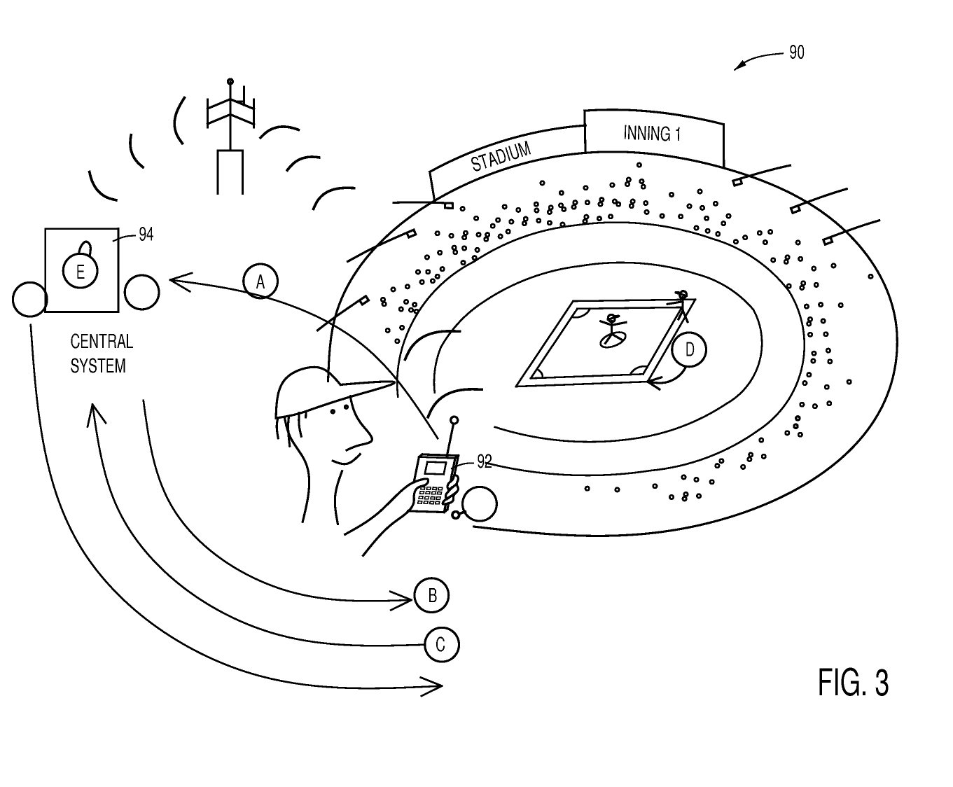

FIG. 3 illustrates an example of an event-based participant-triggered scenario 90 as might be implemented by an exemplary embodiment according to the invention. In this scenario, a participant is at a live event such as a sports venue and wishes to participate in a series of messages sent by centralized computer system or software program (also referred to as “computer”, “system”, “server” and/or combinations thereof).

By using an SMS-compatible device 92 associated with the participant's account, the participant sends a SMS message to a predetermined code. This code is communicated (see arrow A) through a cellular provider to a centralized computer system or software program 94. The centralized computer system or software program 94 recognizes the user as a registered participant for the messaging service and begins using SMS communication to send a series of sports-related messages as indicated by arrow B. The user receives the SMS message from the centralized computer system or software program 94 and responds with their choice of replies via a communications device as indicated by arrow C. An event occurs based on the sports activity as indicated by arrow D. The centralized computer system or software program 94 validates the user's response against the event choice as indicated by the encircled E. If correct, the system adds an associated point total to the participant's account. If incorrect, no points are added. The centralized computer system or software program sends a reply SMS message with the participant's current point total and a message notifying the participants of a correct or incorrect response as indicated by arrow F. The messages continue from the centralized computer system or software program 94 to the participant during a determined timeline or until a specific SMS request is sent by the participant to the centralized computer system or software program 94.

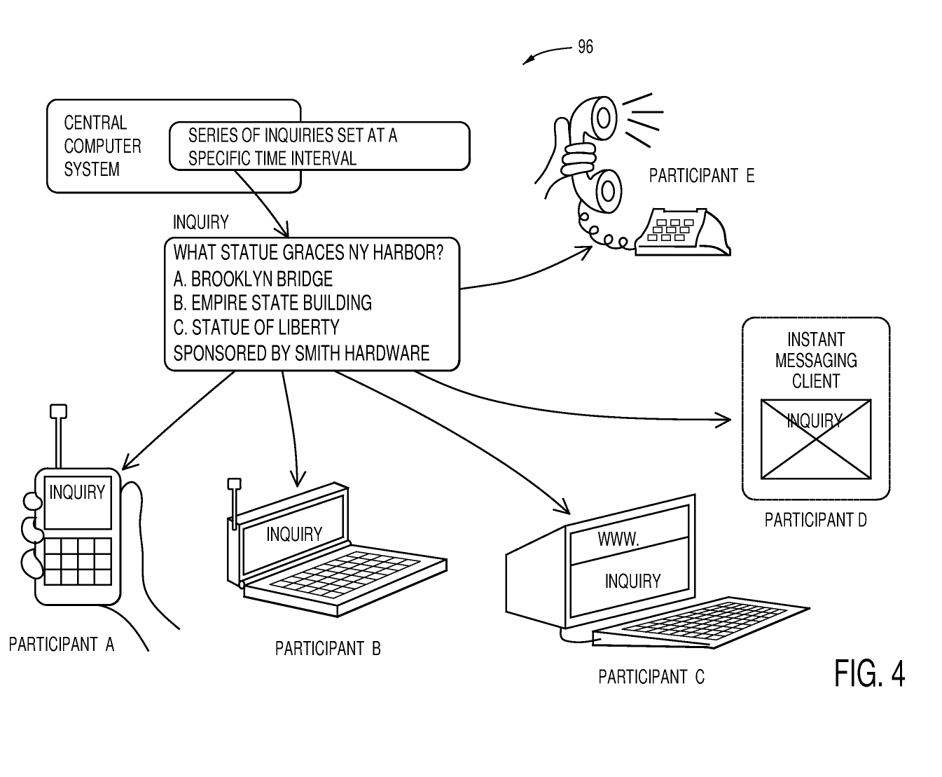

FIG. 4. illustrates an example 96 of group play using multiple devices for interaction as may be implemented according to an exemplary embodiment of the inventions. FIG. 4 highlights the use of multiple interactive devices by individuals (also referred to as “participants”, “users”, and/or “consumers”) to participate in a trivia-based question and answer game. Participant A utilizes a cellular (also referred to as “mobile” or “wireless”) phone (or unit) to answer an inquiry (also referred to as “message”) sent by the centralized computer system or software program. Participant B utilizes a wireless Internet-connected device to respond to the inquiry. Participant C utilizes a personal computer to interact with the centralized computer system or software program. Participant D replies to the inquiry via an Instant Messaging client. Participant E interacts with the centralized computer system or software program through an interactive voice response system to reply to the inquiry. Participant F utilizes a television remote control to respond to a television-broadcasted content originating from the centralized computer system or software program. Participant G responds to a digitally recorded video device. All participants are interactive with the centralized computer system or software program for an identical inquiry and are rewarded a point value to their individual account regardless of communication method.

From the foregoing description of the exemplary embodiments of the inventions, alternatives, additions, and operations thereof, other embodiments will suggest themselves to those skilled in the art. Therefore, the scope of the inventions is to be limited only by the claims below and equivalents thereof.

We claim:

1. A method for a user to earn an award in return for being presented information, comprising:
A. receiving query preference information from the user;
B. sending a message to the user at least including a query according to the query preference information and including presentation information;
C. receiving a query response from the user;
D. sending at least a score to the user;
E. repeating actions B-D at least once but with a new query according to the query preference information, a new query response, and a new score in each repetition;
F. calculating a total score for the user;
G. receiving a request from the user to redeem the total score for the award; and
H. providing the award to the user.

2. The method of claim 1, further comprising:
receiving registration information from the user; and
making the registration information available to a source associated with the presentation information.

3. The method of claim 1, further comprising:
receiving registration information from the user; and
sending a registration score to the user to be included as part of the total score of the user.

4. The method of claim 1, further comprising:
receiving registration information from the user; and
selecting the presentation information based on the registration information.

5. The method of claim 1, further comprising:
selecting the presentation information based on the query preference information.

6. The method of claim 1, wherein the query preference information comprises preferred query subject matter.

7. The method of claim 1, wherein the query preference information comprises preferred query delivery frequency.

8. The method of claim 1, wherein the query preference information comprises identification of a preferred query destination of the user.

9. The method of claim 1, wherein the query preference information comprises preferred query day and time.

10. The method of claim 1, wherein the query preference information comprises an event.

11. The method of claim 1, wherein sending the score comprises sending at least the score and the presentation information to the user.

12. The method of claim 1, wherein the score is based on the query response of the user.

13. The method of claim 1, wherein repeating the actions B-D at least once comprise changing content of the presentation information for each repetition.

14. The method of claim 1, further comprising:
receiving a referral of another user from the user; and
sending a referral score to the user to be included as part of the total score of the user.

15. The method of claim 1, further comprising:
substantially concurrently with the sending of the message including the presentation information to the user, reporting the sending to a third party.

16. The method of claim 1, further comprising:
creating a report including the query preference information of the user and the sending of the message to the user.

17. The method of claim 1, further comprising:
making a report of one or more of actions A-H.

18. The method of claim 1, further comprising:
making a report including information related to the inclusion of the presentation information in a message sent to a user; and
making the report available to a source of the presentation information.

19. A method of providing an incentive to view information, comprising:
transmitting at least a response opportunity including the information;
receiving a response;
based on the response, awarding at least a point towards a point total;
providing an opportunity to earn at least an additional point towards the point total;
receiving a request to redeem the point total for a reward; and
providing the reward in redemption of the point total.

20. A method of getting a consumer to view advertisements, comprising:
creating a message including at least advertising and information soliciting a response from the consumer;
sending the message to the consumer;
receiving the response from the consumer;
awarding a point reward for the response;
informing the consumer of the point reward; and
allowing the consumer to redeem the point reward for an award, or to accumulate an additional point reward by responding to another message including another advertisement,
whereby the prospect of the award gets the consumer to view the advertisements.
